(19) United States
(12) Patent Application Publication
(10) Pub. No.: US 2022/0341900 A1
(43) Pub. Date: Oct. 27, 2022

(54) Methods for performing a thin layer chromatography

(71) Applicants: Tadeusz H Dzido, Lublin (PL); Aneta HALKA-GRYSINSKA, Lublin (PL); Anna KLIMEK-TUREK, Lublin (PL); Radoslaw L. GWARDA, Siennica Nadolna (PL)

(72) Inventors: Tadeusz H Dzido, Lublin (PL); Aneta HALKA-GRYSINSKA, Lublin (PL); Anna KLIMEK-TUREK, Lublin (PL); Radoslaw L. GWARDA, Siennica Nadolna (PL)

(21) Appl. No.: 17/863,217

(22) Filed: Jul. 12, 2022

Related U.S. Application Data
(63) Continuation-in-part of application No. 16/611,240, filed on Nov. 6, 2019.

(30) Foreign Application Priority Data
May 19, 2017 (PL) PL421538A

(51) Int. Cl. G01N 30/93

(52) U.S. Cl. CPC G01N 30/93

(57) ABSTRACT

A method of performing a thin layer chromatography comprises a step of providing a three-dimensional machine configured to move a rigid nozzle under control by a computer along a stationary adsorbent layer, the nozzle combines the ends of individual tubing carrying individually-controlled flows of eluent components, a step of individually operating a plurality of pumps for pumping individual eluent components through the respective tubing towards the rigid nozzle, a step of operating the three-dimensional machine for moving the rigid nozzle adjacent and along the outer surface of the adsorbent layer while continuing to pump individual eluent components, a step of operating a camera connected to the computer to observe a migration of the eluent front on the adsorbent layer, and a step of individually adjusting flow rates of individual pumps by the computer using a dynamic position of the eluent front as observed by the camera.

### CROSS-REFERENCE DATA

This US Patent Application is a continuation-in-part of the co-pending U.S. patent application Ser. No. 16/611,240 filed 8 May 2018 entitled “The method of liquid delivery to the adsorbent layer”, which in turn claims a priority date benefit via the International Patent Application No. PCT/PL2018/000046 with the same title to the Polish Patent Application No. PL421538A filed 9 May 2017, all of which are incorporated herewith in their respective entireties by reference.

### BACKGROUND

Without limiting the scope of the invention, its background is described in connection with methods of conducting liquid chromatography. More particularly, the invention describes methods of performing thin layer chromatography, also referred to as planar chromatography.

A thin layer chromatography is broadly based on delivering the eluent to the thin adsorbent layer of the chromatographic plate, enabling the development of thin layer chromatograms with the preservation of fixed qualitative and quantitative composition of the eluent or/and with a shift of its qualitative and quantitative composition during the process of analytical and preparative separation as well as during the preparation of sample solutions for qualitative and quantitative analysis with the use of instrumental techniques.

In the current state of the art, the development of isocratic thin-layer chromatograms, that is with the preservation of fixed qualitative and quantitative composition of the eluent, is performed through the simple contact of the eluent solution, located at the bottom of a jar or in a special reservoir, with the adsorbent layer of the chromatographic plate. The process of chromatogram development is led in conventional or horizontal chambers. In the former case, these are usually glass containers, cuboidal or cylindrical, where the appropriate volume of eluent solution is poured at its bottom. The chromatographic plate, with substance solutes applied to the start line, is then submerged to a small depth in the eluent, causing its sorption via capillary forces into the adsorbent layer such that the chromatogram development occurs automatically. It is stopped when the eluent front reaches the opposite border of the chromatographik, plate or earlier. This method of eluent delivery to the adsorbent layer of the chromatographic plate, as well as the method of chromatogram development, is the oldest and still often used in the laboratory practice, and is reported in the literature, i.e.: J. Gasparic, J. Huracek. Laboratory handbook of paper and thin-layer chromatography, Ellis Horwood, Ltd., Chichester 1978 or by F. Geiss, Fundamentals of thin-layer chromatography (Planar chromatography), Htithig, Heidelberg, 1987.

In the case of the second type of chamber, the chromatographic plate is placed in a horizontal position in the chamber and the eluent reservoir is situated approximately at the same height. The initiation of chromatogram development, that is eluent delivery to the chromatographic plate, takes place after contacting the eluent solution with the adsorbent layer. The interruption of the chromatogram development is performed by pulling the chromatographic plate out of the chamber or moving this plate away from the eluent reservoir once the eluent front reaches the desired migration distance, usually the middle or end of the plate. This development method is known, among others, from patent descriptions in PL161388 B1, “The mode and the chamber for development of thin-layer chromatograms”, and PL165042 B1, “The mode and the chamber for simultaneous development of two thin-layer chromatograms”.

The above chromatogram development methods, in the conventional or horizontal chambers, are used to separate mixtures of substances, as well as to prepare samples for subsequent quantitative instrumental analysis. The former application is described in literature, such as by C. Oellig, W. Schwack, Planar solid phase extraction—A new clean-up concept in multi-residue analysis of pesticides by liquid chromatography-mass spectrometry, Journal of Chromatography A, 1218 (2011) 6540-6547; as well as by A. Klimek-Turek, M. Sikora, M. Rybicki, T. Dzido, Frontally eluted components procedure with thin layer chromatography as a mode of sample preparation for high performance liquid chromatography quantitation of acetaminophen in biological matrix, J. Chromatogr. A 1436 (2016) 19-27.

The development of gradient chromatograms, that is with a change of qualitative and quantitative composition of the eluent, in both types of chambers described above, can be carried out by changing the mobile phase solution during the development process. However, this development is troublesome because it requires constant supervision of the operator. Moreover, the development of chromatograms in conventional chambers is not economical due to large solvent consumption. The method of gradient chromatogram development is known, among others, from publications by E. Soczewmski, L. K. Czapinska, Stepwise gradient development in sandwich tanks for quasi-column thin-layer chromatography. J, Chromatogr. 168 (1979) 230; as well as by G. Matysik, W. Markowski, E. Soczewinski, B. Polak, Computer-aided optimization of stepwise gradient profiles in thin-layer chromatography. Chromatographia 34 (1992) 303; and by W. Golkiewicz, Gradient development in thin-layer chromatography, in Handbook of Thin-Layer Chromatography, J. Sherma, B. Fried (eds.) Marcel Dekker, Inc., New York, Basel, 2003.

A further known method for supplying the eluent to a chromatography plate is one in which the adsorbent layer is indirectly contacted with the eluent contained in the reservoir, In this case, the eluent is supplied to the adsorbent layer by means of a wick of blotting paper. One end of the paper wick is immersed in the eluent contained in the reservoir, and the other end touches the adsorbent layer, This combination allows for the eluent solution to be transported through the paper strip to the chromatographic plate adsorbent layer and is described in M. Brenner, A. Niederwieser, Overrun thin layer chromatography. Experientia 17 (1961) 237-238. Mile this way the isocratic development of chromatograms is usually carried out, it is not used for gradient development. The consumption of solvents is extremely small, much smaller than during the conventional development of chromatograms.

Another known method uses a porous block to transport the eluent from the reservoir to the adsorbent layer. In this method, the porous block is partially immersed in the eluent solution and the upper part touches the adsorbent layer of the chromatographic plate located horizontally. Capillary forces generated in the porous block are used to transport the eluent solution from the reservoir to the adsorbent layer. This method is described in the literature by L. Kraus, Concise practical book of thin-layer chromatography, Desaga, Heidelberg, 1993. This method is also practically used only for the isocratic development of chromatograms. Its advantage is the relatively low consumption of solvents.

It should be noted that all of the above-mentioned methods can be used for the multiple chromatogram development, which consists of successive multiple developments and evaporations of the eluent. In the subsequent stages of such a process, an eluent with an altered quantitative and/or qualitative composition can be used. That is why multiple chromatogram development can be classified as gradient development. Various versions of this method are described in more detail by B. Szabady, The Different Models of Development, in Planar chromatography in A retrospective view for the third millennium, Sz. Nyiredy (ed.), Springer, Budapest, 2001. one disadvantage of this method of development is the long time of the separation process and high consumption of solvents.

The need, therefore, exists for an improved method for developing a thin layer chromatogram that is void of the drawbacks and limitations of the prior art.

### SUMMARY

Accordingly, it is an object of the present invention to overcome these and other drawbacks of the prior art by providing a novel method of developing a thin layer chromatogram.

It is a further object of the present invention to provide novel methods of developing a thin layer chromatogram while minimizing the volume of solvents and other individual eluent components used in the process of this development.

In a broad sense, the novel method of developing a thin layer chromatogram may include the following steps:
a. providing a chromatography apparatus based on a three-dimensional machine configured to move a rigid nozzle under control by a computer along a stationary adsorbent layer retained therein. In some aspects, the rigid nozzle may be connected to multiple tubing, wherein each tubing is configured to conduct a flow of an individual liquid eluent component therethrough and release thereof from an opening at an open end of the tubing located at the rigid nozzle. In another aspect, individual eluent components may be different from each other in at least one of a qualitative composition or a quantitative composition thereof,
b. individually operating a plurality of pumps for pumping individual eluent components through the respective tubing towards the rigid nozzle, wherein operating of the plurality of pumps is conducted at variable flow rates controlled by the computer to cause flowing thereof from the respective tubing openings. The tubing openings may be positioned at close proximity to each other in the rigid nozzle or in the collector portion thereof. The nozzle may be positioned close to an outer surface of the adsorbent layer so as to cause mixing and aggregating of individual eluent components in a space between the plurality of tubing openings and the adsorbent layer when the individual eluent components are flowing therethrough. This mixing causes the formation of the eluent stream of multiple individual eluent components on the outer surface of the adsorbent layer. In some aspects of the invention, the eluent stream may be characterized by a moving eluent front surrounding the volume of the eluent stream emanated from the rigid nozzle onto the outer surface of the adsorption layer, wherein the eluent front may be migrating on the adsorbent layer in response to the individual operating of the plurality of pumps,
c. operating the three-dimensional machine for moving the rigid nozzle adjacent and along the outer surface of the adsorbent layer at a specified distance therefrom while continuing to pump individual eluent components for depositing the aggregated eluent stream along a set path on the adsorbent layer,
d. operating a camera connected to the computer to observe a migration of the eluent front on the adsorbent layer, and
e. individually adjusting flow rates of individual pumps in steps (b) and (c) by the computer using a dynamic position of the eluent front as observed in step (d) by the camera connected thereto, including using the observed speed of eluent front migration on the adsorbent layer or the distance between the eluent front and the predetermined target position thereof on the adsorbent layer.

Controlled deposition of the eluent stream on the adsorbent layer may be done to control delivery of the eluent stream to a desired location on the adsorbent layer to cause sorption thereof to develop the thin layer chromatogram thereon suitable for subsequent quantitative analysis.

In embodiments, the path of the movement of the rigid nozzle may be determined in advance and may be in any desired shape, such as that of a straight line, a broken line and/or a closed line. The path can also consist of many separate lines, in which case the flow of eluent components stops while the nozzle is traveling between the lines.

The nozzle delivering the liquid stream may be moved along the preset path, including in a repeated back-and-forth manner from the first turning point to the second turning point and back again. The travel speed from the first turning point to the second turning point may differ from the travel speed from the second turning point to the first turning point, especially the travel speed from the first turning point to the second toning point may be lesser than the travel speed from the second turning point to the first turning point. The travel speed of the rigid nozzle and the individually controlled flow of each eluent component emanated therefrom is what together defines the final amount and location of the aggregated eluent deposited over the adsorbent layer.

The first turning point and the second turning point may be arbitrarily located relative to the adsorbent layer, including circumstances where they can lie below or above the adsorbent layer, and they can also lie outside the outline of the adsorbent layer.

The aggregated eluent liquid stream may be moved preferably in one direction, at a constant or variable speed, and especially along the path in the shape of a dosed line. The eluent stream may also be moved successively over the outer surfaces of at least two or more separate adsorbent layers.

The flow rate of the eluent stream or its constituents may vary over time, and in particular, the flow rate of the aggregated eluent stream may be equal to or lower than the absorption rate of the eluent by the adsorbent layer, In one particular example, the eluent stream flow rate may be greater than the absorption rate of the eluent streamby the adsorbent layer. In this situation, the excess liquid is preferably removed by gravity and collected in a gutter, and then if required, the solid contaminants may be separated and the missing components refilled, and then re-supplied to the adsorbent layer.

The quantitative and qualitative composition of the eluent may change over time. To accomplish this, the individual components of the eluent stream may be separately pumped at variable flow rates as controlled by the computer. Individual eluent components may then be combined directly into an aggregated eluent stream prior to or on the outer surface of the adsorbent layer. As each eluent component is pumped via individual tubing, in order to improve the mixing of eluent components, the eluent stream may be stimulated by transverse vibrations of the rigid nozzle.

In another embodiment, each eluent component may be pumped via a separate flexible tubing to the collector at the nozzle in which they are joined, after which the aggregated eluent solution may be delivered through a common rigid tubing outlet onto the outer surface of the adsorbent layer.

In some embodiments, he rigid tubing may have a form of an opening in the collector wall. The liquid stream axis may be oriented perpendicular to the outer surface of the adsorbent layer, such that when the eluent is pumped with a flow rate greater than the absorption rate of the adsorbent layer, the stream axis intersects the outer surface of the adsorbent layer at an acute angle.

Depending on the purpose of he liquid delivery, the liquid stream may be located below or above the adsorbent layer.

During the delivery of the eluent stream to the adsorbent layer, the progress of the eluent front migration is observed on the adsorbent layer by a camera operatively connected to the computer which is configured to adjust the flow rate of the eluent stream and/or its components as they are being pumped accordingly.

The individual components of the eluent stream may be pumped in a form of separate liquid streams, which, depending on the needs, may include specific solvents, their solutions, and/or solutions of substances in solvents.

The present invention contributes to the goal of minimizing the use of solvents composing the eluent stream. Due to the variable and individually-controlled flow rate of individual eluent components, the method of the invention allows for the desired gradient development of the chromatograms while minimizing the gradient delay associated with the mixing of these components. This feature allows performing the gradient chromatogram development process accurately and precisely.

The method also allows for controlled delivery of the eluent to the adsorbent layer, particularly at a slower flow rate than that resulting from the rate of absorption of the eluent through the adsorbent layer as a result of capillary action. This feature of the method contributes to eliminating the excess flow of the eluent onto the surface of the adsorbent layer during the development of the reverse-phase chromatograms, Moreover, the method of the invention can be used much more easily for the automatic chromatogram development for analytical and preparative separation and for the preparation of samples for analysis with instrumental techniques compared to methods known from the current state of art. In particular, utilization of the proposed method for the preparation of samples for chemical analysis with instrumental techniques may be beneficial due to the possibility of supplying the eluent to any place on the adsorbent layer, which contributes to facilitating the separation of target chemical substances from other components of the matrix and/or concentration/focusing of the target compounds in a form of the smallest possible zone in a specific desired target position on the adsorbent layer.

A further important advantage of the proposed method is the minimized consumption of the eluent because it is deposited to be equal to or slightly greater than the volume absorbed by the adsorbent layer. Therefore, the consumption of solvents during the development of chromatograms with the proposed method is comparable to their consumption in horizontal chambers, which is at least several times lower than the development of chromatograms in conventional chambers.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additionalspecificity and detail through use of the accompanying drawings, in which:

FIG. 1 shows the schematic diagram of the eluent delivery system;

FIG. 2 shows the enlarged detail “A1” from FIG. 1;

FIG. 3 shows the view W1 from the direction indicated in FIG. 2;

FIG. 4 shows the alternative enlarged detail “A2” from FIG. 1;

FIG. 5 shows the view W2 from the direction indicated in FIG. 4;

FIG. 6 shows he chromatogram image obtained in Example I;

FIG. 7 is the schematic diagram of the first alternative system for the eluent delivery;

FIG. 8 shows the chror atogram image obtained in Example II;

FIG. 9 shows the schematic diagram of the second alternative system for the eluent delivery;

FIG. 10 shows a view of the inside of the chamber of the second alternative system from the direction W3 indicated in FIG. 9;

FIG. 11 shows the view of the plate with applied internal standard solutions and test solutions in order to conduct the instrumental analysis according to Example III;

FIG. 12 shows the two stages of the chromatogram development on the plate shown in FIG. 11;

FIG. 13 shows the view of the plate shown in FIG. 11 after a step of concentration of the spots;

FIG. 14 shows the view of the plate prepared for the instrumen a analysis according to Example IV,

FIG. 15 shows the view of the plate shown in FIG. 14 after the chromatogram has been developed;

FIG. 16 shows the view of the plate shown in FIG. 14 after the initial concentration;

FIG. 17 shows the view of the plate prior to final concentration;

FIG. 18 shows the view of the plate prepared for the chromatogram development according to Example V; and

FIG. 19 shows he view of the plate with the developed chromatogram.

### DETAILED DESCRIPTION OF PREFERRED EMBODIMENTS OF THE INVENTION

The following description sets forth various examples along with specific details to provide a thorough understanding of claimed subject matter. It will be understood by those skilled in the art, however, that claimed subject matter may be practiced without one or more of the specific details disclosed herein. Further, in some circumstances, well-known methods, procedures, systems, components and/or circuits have not been described in detail in order to avoid unnecessarily obscuring claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments ⁻nay be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure,

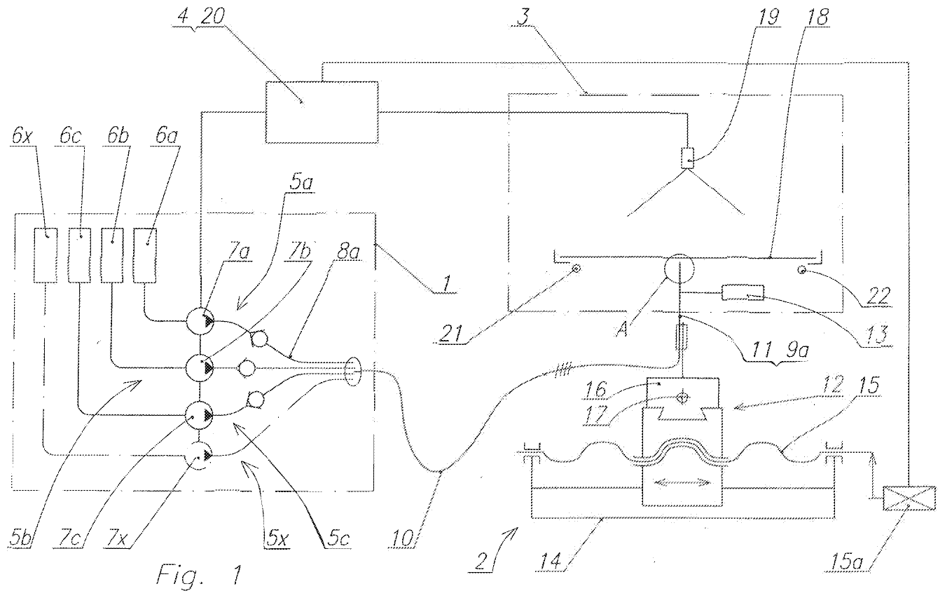

FIG. 1 shows the schematic diagram of a basic system for delivering the eluent to the adsorbent layer, The system consists of a hydraulic unit (1), a three-dimensional machine (2), a chromatographic chamber (3), and a computerized control unit (4).

The hydraulic unit consists of a series of identical supply lines (5a, 5b, 5c, . . . 5x). The first supply line (5a) consists of the first reservoir (6a) connected to the first pump (7a), which has the outlet to which the first flexible tube (8a) is connected to and then terminated with the first rigid tube (9a). All the flexible tubes (8a, 8b, 8c 8x) along with the rigid tubes (9a, 9b, 9c, 9x) are connected into a bundle (10) at a certain part of the length. The tip (11) of the bundle (10) is attached to the support (12) of the three-dimensional machine (2). The reservoirs (6a, 6b, 6c 6x) are intended for the eluent or its separate components, which, depending on the needs, may include specific solvents, their solutions and/or solutions of substances in the solvents. The tip (11) adheres to the working segment of the vibrator (13), which, if necessary, stimulates it to vibrate in a transversal direction for better mixing of solutions pumped through rigid tubes (9a, 9b, 9c, 9x), wherein the vibration amplitude does not exceed several internal diameters of the rigid tube (9a).

The three-dimensional machine (2) consists of a base (14) to which the first lead screw (15) is mounted together with the support (12) with a transverse carriage (16) driven by the second lead screw (17). The first lead screw (15) is driven by the first electric motor (15a) and the second lead screw (17) is driven by the second electric motor not shown in the drawing. The three-dimensional machine (2) allows the tip (11) of the bundle (10) to travel along the two mutually perpendicular directions, under almost the entire surface of the chromatographic plate (18), hereinafter referred to as the “plate” (18).

inside the chromatographic chamber (there is a plate (18), which may be retained in a horizontal position, oriented with the adsorbent layer directed downwards, while over the plate (18) there is a camera (19) mounted to observe the progress of the migration of the eluent front. The camera (19) is connected to a computer (20), which sin ultaneously controls the operation of the pumps (7a, 7b, 7c. . . 7x) and the three-dimensional machine (2), and the position of the tip (11) of the rigid nozzle relative to the entire surface of the plate (18), for example, starting from the first turning point (21) to the second turning point (22) along the path that lies in the plane of the drawing.

The control unit (4) consists of a computer (20) in combination with a camera (19) and electric executive elements, including circuit snitchers incorporated in the electric supply circuits of the pumps (7a, 7b, 7c. . . 7x) and electric n otors (15a) driving the lead screws (15, 17).

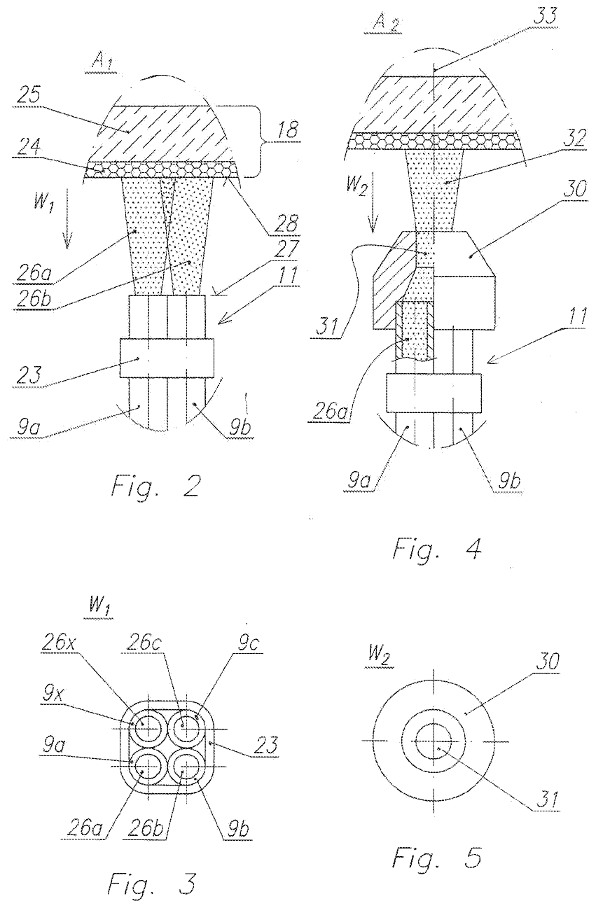

FIG. 2 shows the enlarged detail “A” comprising the nozzle tip (11) and the plate (18), and FIG. 3 shows the top view of the tip (11) from the side of the plate (18). The tip (11) in this example consists of four rigid tubes adjacent to each other (9a, 9b, 9c, ... 9x) and connected by a band (23). The plate (18) in turn consists of an adsorbent layer (24) adhering to the carrier plate (25) made of a transparent material. Individual eluent component liquid streams (26a, 26b, 26c. . . 26x) flow out from each of the rigid tubes (9a, 9b, 9c, 9x) and combine to thereby mixing between the outer edge (27) of the nozzle tip (11) and the outer surface (28) of the adsorbent layer (24) and then also being delivered thereon.

FIG. 4 shows the enlarged detail “A” showing how the tip (11) could be built. The tip (11) is equipped with a nozzle (30) inside which the single streams (26a, 26b, 26c. . . 26x) join in a collector portion and the combined eluent stream (32) flows out through the exit hole (31), the axis (33) of which is perpendicular to the outer surface (28) of the adsorbent layer (24).

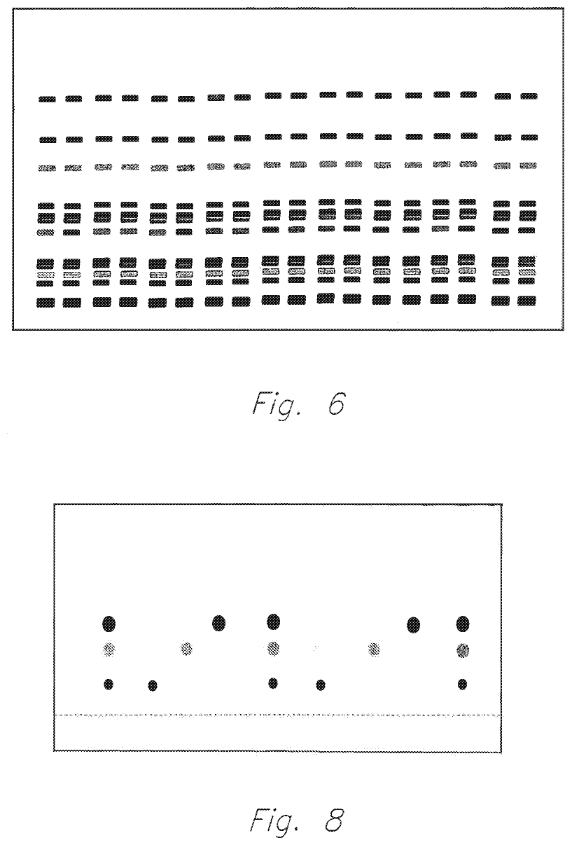

FIG. 5 shows the nozzle (30) from a top view. The nozzle (30) is in the form of a rotatable solid, and its axis (33) has the exit hole (31).

EXAMPLE I

The arrangement shown in FIGS. 1, 3, and 4 was used to supply the eluent according to the method of the invention in order to separate the mixture by gradient elution, using only the first two supply lines (5a, 5b). The first supply line (5a) delivers the first solution, which is a solution of 100 mM trifluoroacetic acid in methanol. The second supply line (5b) provides the second solution, which is a solution of 100 mM trifluoroacetic acid in water. As a plate (18), a 10×20 cm HPTLC RP-18W chromatographic plate from Merck was used, on which 2 μL volume portions of test dye mixture were applied in eighteen places to the start line, positioned in parallel to the long edge of the plate (18). The portions of the test mixture were applied using the Camag's Linomat V semi-automatic sample applicator. The space between the cylinder and the piston of the 20 mL syringe was used as the reservoir, and the syringe pump was used as a positive displacement pump. The drive mechanism of a three-dimensional printer was used as a three-dimensional machine (2). Flexible tubes (8a, 8b, 8c. . . 8x) were made of Teflon with an internal diameter of 0.2 mm and external diameter of 1.6 mm, while rigid tubes (9a, 9b, 9c, 9x) were made of stainless steel tubes with an internal diameter of 0.2 mm and external diameter of 0.8 mm. The distance of the nozzle (30) from the surface of the adsorbent layer was set to 0.1 mm, with the exit hole diameter being 0.5 mm, and the movement speed from the first turning point (21) to the second turning point (22) was 30 mm/s and the return speed was 100 mm/s.

In order to develop the chromatogram, the previously prepared plate (18) is placed in the chromatographic chamber (3), in which the tip (11) is positioned from below. The first solution is then pumped until the first flexible tube (8a) and the rigid tube (9a) are filled and the second solution is pumped until the second flexible tube (8b) and the second rigid tube (9b) are filled. The total pumping yield of both solutions was set before the experiment and was between 2 and 5 mL/h, which is below the absorption rate of the eluent by the adsorbent, wherein with the first pump (7a) delivers the first solution with a flow rate of 1.6 to 3.0 mL/h and the second pump (7b) pumps the second solution in a flow rate of 0.2 to 3.0 mL/h.

The tip (11) is terminated with the nozzle (30) and is then set at the first turning point (21). Using the three-dimensional machine (2), it is then moved to the second turning point (22) and back, while simultaneously both solutions are pumped with variable respective flow rates controlled by the computer (20). The pumping flow rate of both solutions was programmed to obtain the following percentage concentrations of both solutions depending on the distance traveled by the eluent front:
1) 40% of the first solution plus the second solution to add up to 100%, the distance traveled by the front of the eluent from 0 (starting line) to 10 mm, the flow rate of the eluent delivery 5 mL/h,
2) 60% of the first solution plus the second solution to add up to 100%, the distance traveled by the front of the eluent from 10 mm to 20 mm, the flow rate of the eluent delivery 5 mL/h,
3) 70% of the first solution plus the second solution to add up to 100%, the distance traveled by the front of the eluent from 20 mm to 40 mm, the flow rate of the eluent delivery 3 mL/h.
4) 80% of the first solution plus the second solution to add up to 100%, the distance traveled by the front of the eluent from 40 mm to 70 mm, the flow rate of the eluent delivery is 2 mL/h,
5) 90% of the first solution plus the second solution to add up to 100%, the distance traveled by the front of the eluent from 70 mm to 80 mm, the flow rate of the eluent delivery is 2 mL/h.

Both solutions were mixed in the nozzle (30) and further on the outer surface (28) of the adsorbent layer (24), The adsorbent layer (24) is then wetted with the eluent solution, which leads to the development of the chromatogram. At the same time, the digital camera (19) registers the position of the moving eluent front visible through the carrier plate (25) and the signals on the migration position and distance of the eluent front from the target position are collected and sent to the computer (20). The computer (20) is configured to individually control the pumps (7a) and (7b) respectively as well as the movement of the nozzle (30) based on this information to deliver the eluent components, with a programmed ratio, to the adsorbent layer.

After reaching the final target migration distance of the eluent front (about 8 cm from the place where the samples were applied to the plate (18)), the flow of the eluent components was stopped, then the plate (18) was removed from the chromatographic chamber (3) and dried under the hood. As a result, the chromatogram depicted in FIG. 6 was obtained.

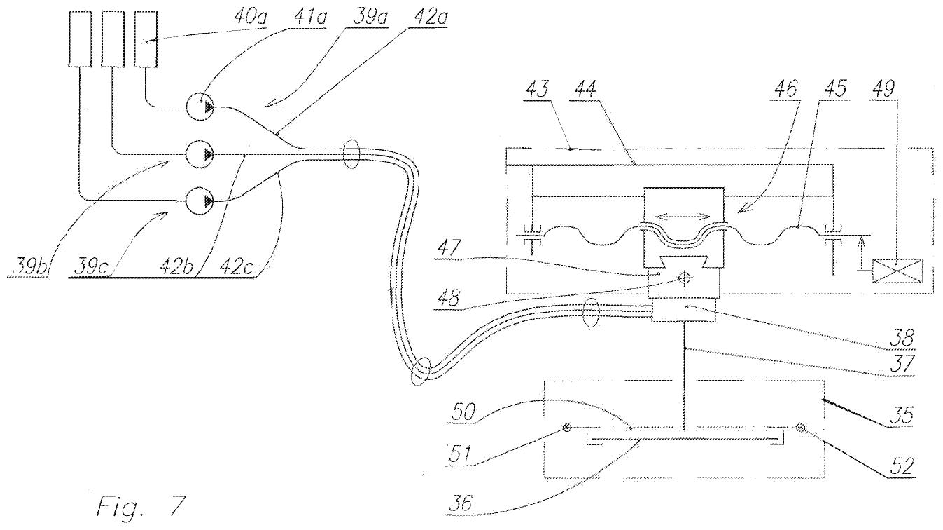

FIG. 7 shows a schematic diagram of the first alternative system for delivering the eluent. This arrangement is presented with the omission of the control unit, which is the same as shown in FIG. 1. Inside the chromatographic chamber (35), there is positioned a plate (36) in a horizontal position oriented with the adsorbent layer facing upwards. Above the plate, there is mounted a rigid tube (37) connected to the collector (38), with three identical supply lines connected to the collector (38) (39a, 39b, 39c). The first supply line (39a) includes the first reservoir (40a) connected to the first positive displacement pump (41a), the outlet of which is connected to the first end of the flexible tube (42a), The second end thereof is connected to the collector (38). The collector (38) is attached to the three-dimensional machine (43).

The three-dimensional machine (43) contains a body (44) to which the first lead screw (45) is mounted together with the support (46) on it and with a transversely located carriage (47) driven by the second lead screw (48). The first lead screw (45) is driven by the first electric motor (49), and the second lead screw (48) is driven by the second electric motor not shown in the drawing.

The three-dimensional machine (43) enables the movement of the collector (38) with the rigid tube (37) along the path of a straight line (50) positioned in the plane of the drawing from the first turning point (51) to the second turning point (52) and along the paths of any shapes over the plate (36), in a rectangular coordinate system.

### EXAMPLE II

The method according to the invention has been used to develop the isocratic chromatogram according to the arrangement shown in FIG. 7. A HPTLC plate (36) manufactured by Merck with dimensions of 5×10 cm has an adsorbent layer in the form of a silica gel. Flexible tubes (42a, 42b, 42c) of 1.6 m external diameter and 0.2 mm internal diameter are made of Teflon. The ends of the tubes are connected to a collector (38) of negligible capacity. The rigid tube (37) is made of a 50 mm long stainless steel tube with a 1.6 mm outer diameter and a 0.2 mm internal diameter. The outlet of the rigid tube (37) moves over the adsorbent layer of the plate (36). A specific composition of the solution supplied to the adsorbent layer is obtained through the appropriate rate of of delivery of the individual eluent components from the supply lines (39a, 39b, 39c), namely toluene, ethyl acetate, and methanol, respectively. In this particular case, the function of the rigid tube (37) is performed by the outlet hole in the collector wall (38).

On the start line, 1 cm from the edge of the plate (36) and parallel to it, the solutions in the count of 9 were applied, namely mixtures of three dyes (3 places of application on the starting line) and solutions of individual dyes (6 places-2 places for each dye: orange, yellow and blue) using the Linomat 5 aerosol applicator by Camag. Next, an eluent was supplied to the adsorbent layer, which was pure toluene from the first supply line (39a). The distance between the end of the rigid tube (37) and the adsorbent layer was 0.2 mm and the length of the moving path was greater than the width of the plate (36). The set path was between the first turning point (51) and the second turning point (52). This line ran between the starting line and the closest parallel edge of the plate (36). The travel speed of the tip of the rigid tube (37) above the plate (36) was constant in both directions and was set at 30 mm/s, while the speed of toluene delivery to the adsorbent layer during the chromatogram development process was also constant and set at 5 mL/h. No other liquids were pumped through the other two supply lines (39b, 39c) in this experiment. Once the eluent front has traveled the distance of 4.0 cm from the starting line, the flow of solvent was stopped. The duration of this process was 10 minutes. The chromatographic plate was then dried and photographed. The image of the chromatogram obtained is shown in FIG. 8.

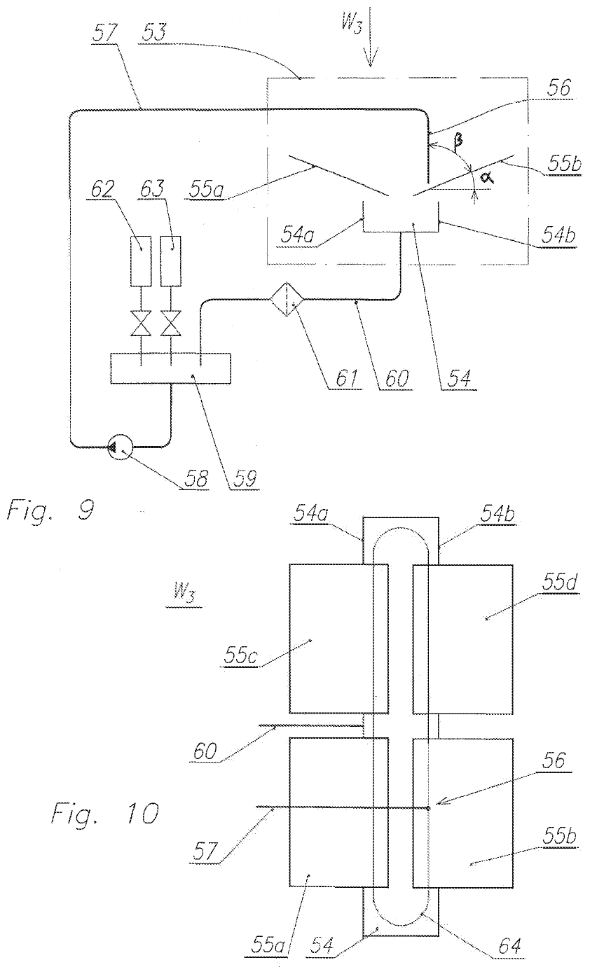

FIG. 9 is a schematic diagram of the second alternative system for delivering the eluent stream. A gutter (54) is formed in the chamber (53) above which the plates (55a, 55b) are placed at an angle relative to the level and directed with the adsorbent layer facing upwards. The first plate (55a) is above the first side (54a) of the gutter (54), and the second plate (55b) is above the other side (54b). However, there is a rigid tube (56) over the second plate (55b) connected via a flexible tube (57) and a pump (58) connected to the reservoir (59). The rigid tube (56) can also move over the first plate (55a) as driven by the three-dimensional machine, not shown in the drawing, to which it is attached, which is designed like the three-dimensional machine (43) shown in FIG. 7. The eluent stream axis of the liquid flowing out of the rigid tube (59) intersects the second plate (55b) at an acute angle β. The reservoir (59). on the other hand, is connected to the gutter (54) via the drain line (60) on which the filter (61) is mounted. Two dispensers (62, 63) are also connected to the reservoir (59).

In order to supply the eluent to the adsorbent layer, the eluent is pumped through the pump (58) to the rigid tube (56) in the amount exceeding the absorption capability of the adsorbent layer, such that the excess liquid flows by gravity into the gutter (54). It then flows further through the filter (61) to the reservoir (59), where the quantity and composition of the eluent is replenished to the initial parameters from the dispensers (62, 63), and then the recycled eluent is further supplied to the adsorbent layer.

FIG. 10 shows the top view of the interior of the chamber of the second alternative arrangement from the direction W3 indicated in FIG. 9. Plates are arranged along the gutter (54). The first series of plates (55a, 55c) is arranged above the first side (54a), and the second series of plates (55b, 55d) is arranged above the second side (54b). Over the second plate, there is a rigid tube (56) which is moved over both rows of plates by the three-dimensional machine (not shown) along the set path in the shape of a closed line (64) at a speed of 200 mm/s.

### EXAMPLE III

The method of the invention has been used to prepare samples for instrumental analysis. In the first stage, nine standard solutions of paracetamol and acetanilide with the volume of 20 μL. are applied with a microsyringe onto a chromatographic plate (65), 10×20 cm HPTLC by Merck with an adsorbent layer of silica gel that is facing upwards along the starting line (66), spaced 1 cm from the long edge (67) of the plate (65). The concentration of acetanilide in these solutions was constant, whereas the concentration of paracetamol was variable. In addition, 20 μL. of the test solution containing an unknown amount of paracetamol and the known amount of acetanilide is applied in each of the further three locations on the start line. FIG. 11 shows the plate (65) with the nine standard solutions and the three test samples applied this way, which were marked 1-9 and X1-X3 respectively.

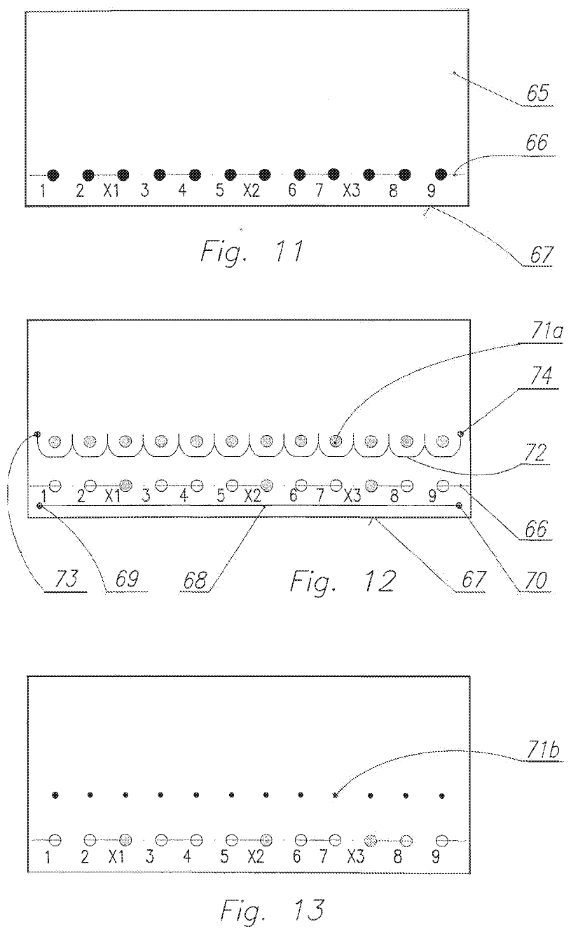

FIG. 12 shows the next two stages of chromatogram development. Once the spots containing solutions of the substances applied to the start line (66) have dried, an isocratic chromatogram was developed utilizing the apparatus shown in FIG. 7 with the use of the third supply line (39c) filled with methanol. In the first stage, the methanol is supplied to the adsorbent layer with a flow rate of 5 mL/h, at a moving speed of the rigid tube (37) equal to 50 mm/s at a distance of 0.1 mm above the adsorbent layer. The rigid tube (37) was moved between the starting line (66) and the position closest to the longer edge (67) of the plate (65) over the distance of 196 mm. This movement was repeated along the straight-line path (68) from the first turning point (69) to the second turning point (70) and back. Methanol was delivered until the eluent front reached a distance of 30 mm from the starting line (66), after which the plate (65) was dried. During the delivery of the eluent, the target substance (paracetamol) and the internal standard (acetanilide) migrated practically along with its front in the form of spots (71a).

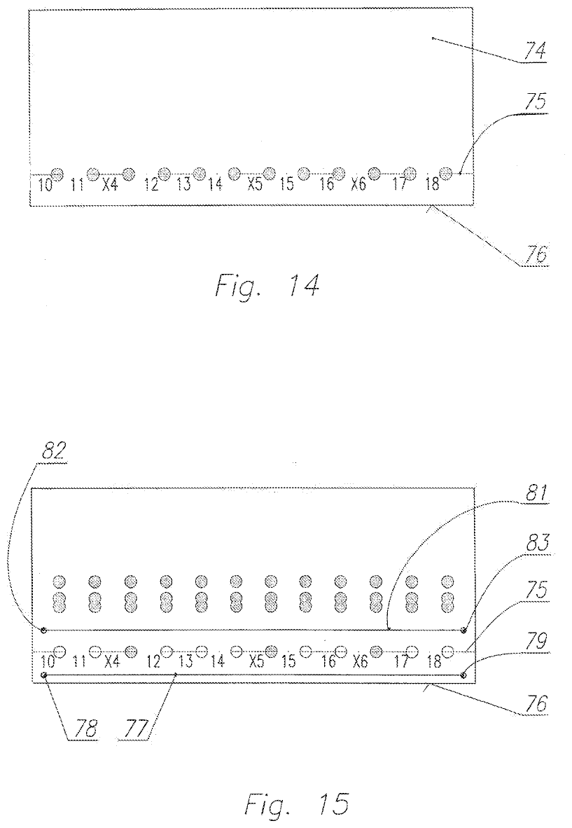

In the next step, the plate (65) was again subjected to methanol delivery to the adsorbent layer to obtain concentrated and narrowed substance zones (paracetamol and acetanilide). The methanol was supplied when the rigid nozzle was moved along a broken line path (72), from the first turning point (3) to the second turning point (74), and surrounding each of the spots (71a) on three sides. The broken line (72) consists of many straight sections and arcs. The methanol was supplied to the adsorbent layer with a flow rate of 2.5 mL/h) at a speed of moving of the rigid tube (37) equal to 20 mm/s. Periodic movement of the rigid tube (37) over the adsorbent layer was interrupted when the adsorbent layer was completely wetted in the area of this path. FIG. 13 shows the concentration effect. The spots (71a) were significantly reduced and concentrated to the points (71b) After evaporation of the solvent (methanol), the adsorbent layer at the location of the respective paracetamol and acetanilide zones was scraped and transferred to separate vessels, followed by adding known amounts of methanol. The obtained suspensions were filtered, and the obtained solutions were subjected to the determination of paracetamol by the well-known method of the internal standard, using high-performance liquid chromatography with a UV detector.

### EXAMPLE IV

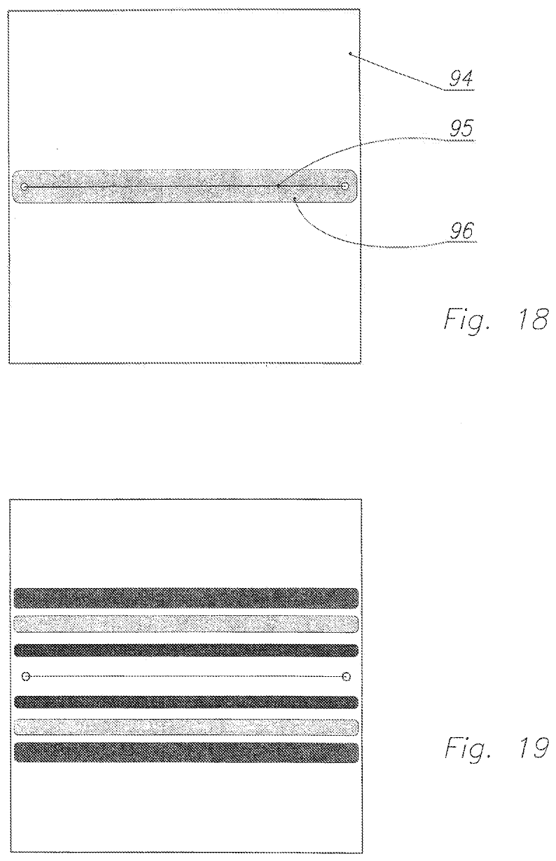

The preparation of a sample for instrumental analysis is shown in the steps in FIGS. 14-17. In a preliminary step, nine standard solutions containing known concentrations of three substances (acetylsalicylic acid, caffeine, and paracetamol) of 20 μL, are applied with a microsyringe onto a 10×20 cm HPTLC RP-18W plate by Merck with a salinized silica gel layer that was positioned along the start line (75), spaced 10 mm from the long edge (76) of the plate (74). The concentration of caffeine in these solutions was constant, while the concentration of acetylsalicylic acid and paracetamol had different values. Then, in three places on the start line (75), 20 pL of the test serum solution containing an unknown amount of acetylsalicylic acid and paracetamol and a known amount of caffeine were applied. FIG. 14 shows the application sites of the nine standard solutions and the three solutions of tested serum, which were marked 10-18 and X4- X6, respectively. The prepared plate (4) was dried.

Simultaneously, the arrangement shown in FIG. 7 was prepared for developing the isocratic chromatogram, in which the first line (39a) is filled with acetonitrile, and the second line is filled with a buffer containing: a solution of 0.2 M sodium monophosphate(V) and 0.1 M solution of citric acid, pH 3.2, and the third line (39c) is filled with methanol. The plate (74) was placed in the chamber (35).

In the next phase, the eluent liquid components were delivered to the adsorbent layer using the first line (39a) and the second line (39b). Both lines (39a, 39b) were operated to supply solutions with different flow rates so that the eluent has a composition of 25% acetonitrile and 75% buffer. The total flow rate of the eluent stream delivery to the adsorbent layer was 5 mL/h. The third line (39c) was not used at this stage of the experiment.

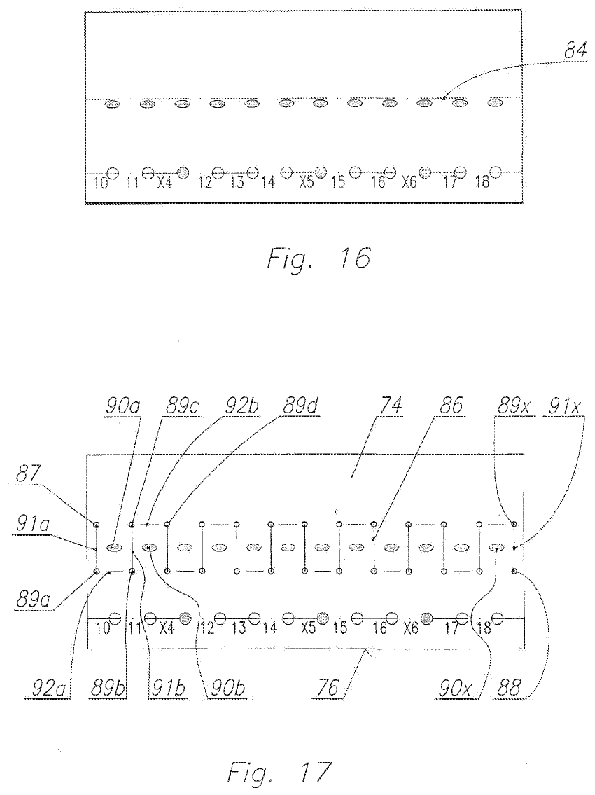

FIG. 15 shows the first and the second stage of chromatogram development. The end of the rigid tube (37) was moved repeatedly over the adsorbent layer between the starting line (75) and the longer edge (76) along the first path (77) in a straight line from the first turning point (78) to the second turning point (79) and back again. The migration speed of the rigid tube (37) was 20 mm/s, and the distance of its tip from the outer surface of the adsorbent was set at a 1 mm.

The development of the chromatogram was stopped when the eluent front reached a distance of 60 mm from the starting line (75). Under these conditions, the substances of interest, namely salicylic acid and paracetamol, as well as the internal standard, namely caffeine, showed values of the retardation coefficient, RF, 0.35, 048, 0.30, respectively. In this state, the plate (74) was dried, and then the second step was administered.

The individual pumps operating the first line (39a) and the second line (39b) were turned off, while the methanol was delivered from the third line (39c) onto the adsorbent layer with a flow rate of 5 mL/h and the travel speed of the nozzle tip of the rigid tube (37) equal to 20 mm/s at a gap distance of 0.1 mm from the adsorbent layer and along the second path (81) in a straight line from the first turning point (82) to the second turning point (83) and back. The second path (81) was 20 mm away from the long edge (76). After reaching a 25 mm front migration distance (84) of methanol, measured from the second path (81), the methanol flow was stopped and the plate (74) was dried. FIG. 16 shows the effect of the second stage of chromatogram development.

In the next phase, shown in FIG. 7, a rigid tube (37) was moved by the three-dimensional machine along the third path in the shape of a broken line (86) from the first turning point (87) to the second turning point (88) via intermediate points (89a, 89b, 89c, 89d . . . 89x) and back to the first turning point (87), skipping the intermediate points (89a, 89b, 89c, 89d . . . 89x). The third path (86) surrounds the subsequent spots interchangeably from three sides (90a, 90b 90x). Methanol, on the other hand, only runs on the vertical sections (91a, 91b . . . ) of the third path (86), with interrupted pumping during the passage of the rigid tube (37) over the horizontal sections (92a, 92b . . . ) parallel to the long edge (76) and in time of return. The methanol flow was stopped when the adsorbent layer between the vertical sections (91a, 91b, . . . ) was completely wetted.

The same phase may also be carried out according to a variant in which the methanol is delivered along the vertical segment (91a) back and forth until the solvent front reaches the center of the spot (90a). At this point, the rigid tube (37) may be moved to the second vertical section (91b) and methanol may be delivered until the first emerging front reaches the center of the first spot (90a), the second front reaches the center of the second spot (90b), and so on until the adsorbent is etted between the vertical sections (91a, 91b, . . . ) of all spots (90a, 90b . . . 90x). As a result of the implementation of this phase, the substance zones (acetylsalicylic acid, caffeine, and paracetamol) were significantly reduced and concentrated.

The substances found in the concentrated zones were extracted with methanol in the usual manner using Camag's TLC-MS Interface device connected to a liquid chromatography pump. This resulted in 12 solutions, corresponding to nine standard solutions and three tested solutions, which were previously applied to the start line. The solutions obtained this way were subjected to the determination of acetylsalicylic acid and paracetamol by a known method in which caffeine was an internal standard, using high-performance liquid chromatography with a UV detector and mass spectrometer.

### EXAMPLE V

The method of the invention had also been used for the separation of a mixture of substances with the use of the system shown in FIG. 7. For this purpose, the first supply line (39a) was filled with a toluene solution of three dyes: 1- aminoanthraquinone, 2-nitroaniline, and the fat green. The second supply line (39b) was filled with toluene, which acts as the eluent here, and the third supply line (39c) was not used. A plate (94) with dimensions of 200×200 mm with an adsorbent layer of 0.5 mm thick silica gel was then placed in the chromatographic chamber. Further, from the first supply line (39a), a dye solution was pumped along the start line (95) constituting the plate axis (94) until a band (96) of dyes to be separated with a width of 10 mm was obtained. At this point, the flow of the dye solution was stopped and the delivery of the eluent was started via the second supply fine (39b) along the path that coincides with the starting line (95). This condition is shown in FIG. 18.

During this process, the eluent wetted the adsorbent layer simultaneously in two opposite directions—from the start line (95) to the opposite edges of the plate (94). When the eluent front reached both opposite edges of the chromatographic plate, the toluene flow was stopped, and the adsorbent layer was dried from the solvent. FIG. 19 shows the chromatograrn obtained in this example with bands of separated dyes. Next, the zones of the adsorbent layer in which the bands of separated substances were located were mechanically transferred to appropriate filters placed in three glass funnels and extracted with methanol. The extracts were collected in three separate vessels. In this way, separate methanol solutions of each dye were obtained. The evaporation of methanol yielded pure dyes.

The migration of the eluent front may be monitored by a camera during chromatograrn development and used as input for the computerized automatic control of individual pumping flow rates and nozzle speed in order to ensure evenly distributed eluent stream front advancement. Image recognition techniques may be used to convert the video recorded by the camera to the moving outline of the eluent front. The migrating front surrounds the eluent stream deposited on the adsorbent layer and advances away from the nozzle as more liquid is released therefrom. A preferred direction may be selected to urge eluent front movement, for example by tilting the adsorbent layer causing gravity forces to preferentially urge the eluent stream in the direction of the lower portion of the adsorbent layer. The speed of the migration is affected by the rate of flow of the eluent stream, the rate of absorption by the adsorbent layer, movement of the nozzle, as well as a number of secondary factors, including evaporation rate of individual eluent components, room temperature, liquid temperature, the humidity of the space surrounding the nozzle, etc.

In plain or conventional chromatogram development, the solvent front moves at a rate that corresponds to the absorption rate of the solvent by the adsorbent layer. The solvent front travel speed decreases with increasing solvent front migration distance according to the equation: u=k/(2 Z), where u is the solvent front travel speed, k is constant, Z is the solvent front migration distance. Let's assume that with the device as described above, the chromatogram development is started by applying the solvent to the adsorbent layer with a constant flow rate, selected to be slightly lower, e.g. from 5 to 20% lower, than the rate of solvent absorption by the adsorbent layer (to prevent overflowing of the chromatographic plate). During this chromatogram development, the camera may be used to observe and record the movement of the eluent front and transmit this data to the computer. When the computer registers a slight decrease in the migration rate of the eluent front, e.g., 1% or more, the controller may be configured to send a signal to the pumps to reduce the solvent delivery flow rate by a predetermined value, e.g., 5% to 20%. The individual pumps then deliver the solvent to the adsorbent layer with a constant and reduced flow rate compared to the initial flow ate. When the control system again detects the reduction in the speed of travel of the eluent front, the computer may be configured to again reduce the flow rate of the solvent supply to the adsorbent layer by a predetermined value, for example by another 5 to 20%. This operation of adjusting the flow rate of solvent delivery to the adsorbent layer is repeated unto the solvent front reaches the target distance according to the given recipe of the analysis (at or shortly ahead of that moment, the solvent delivery may be stopped entirely).

In other embodiments of the method, the camera may be used to detect the distance of the advancing eluent from the predetermined target position thereof on the adsorbent layer. As that distance is decreasing, the computer may be configured to slowly reduce the flow rate of individual pumps until the target position of the eluent front is reached, for example using steps of 5-20% flow reduction at a time. The flow may be stopped at that moment or shortly before so as to avoid “overshooting of” the eluent front on the adsorbent layer.

Monitoring the excess flow of solvent at the tip of the moving pipette or nozzle during chromatogram development and temporary halting of pumping and nozzle movement in order to ensure even solvent front advancement may also be used to increase the accuracy of desired eluent stream disposition on the adsorbent layer.

Controlling the flow rate of solvent delivery to the adsorbent layer may further be performed by observing the thickness of the solvent stream in the gap between the tip of the movable nozzle (capillary tip, pipette tip, or movable tube) and the adsorbent layer. This can especially be advantageous if the solvent is supplied to the adsorbent layer directly through a thin capillary or a tube—it ensures that the camera view will remain unobscured. Alternatively, a thin or tapered nozzle can be used. The device may be adapted to record the thickness of the eluent stream flowing from the tip of the movable nozzle with a camera and regulate this thickness by changing (decreasing) the flow rate of the solvent supply to the adsorbent layer. When the computerized controller detects that the tip of the movable nozzle is surrounded by solvent and is imp ersed in the solvent, the computer may be configured to recognize that there is excess solvent delivered, prompting a reduction or a temporary halt in the eluent components delivery—until the problem is resolved. During this time, the lack of excess solvent at the tip of the movable nozzle may lead to a decrease in the speed of the eluent front movement as recorded by the camera. When this reduction in solvent front movement speed reaches a predetermined threshold value (in the range of 5 to 20%), the device may resume the solvent delivery with a reduced flow rate ranging from 5 to 20% lower as compared to the previous flow rate. These operations may be repeated when the effect of increasing the thickness of the solvent stream flowing from the capillary tip occurs again. Alternatively, the device can measure the thickness of the eluent stream and the build-up of solvent at the tip of the movable nozzle by fiber optic measurement of excess solvent at the tip of the nozzle.

Automatic maintenance of the gap distance between the nozzle and the adsorbent layer may be advantageous as compared to a fixed distance between thereof. The width of the adsorbent layer on commercial chromatographic plates may vary by as much as +/−20%. To assure a precise and continuous delivery of the eluent stream to the adsorbent layer, it is important to maintain the constant gap distance between the nozzle tip and the adsorbent layer of about 0.05-1.0 mm and preferably 0.1-0.2 mm.

A fiber-optic distance measurement may be used for automated adjustment of the distance of the nozzle tip from the adsorbent layer. This may be done, for example, by using a beam of two optical fibers attached to the movable nozzle, one of which sends a beam of visible light to the surface of the adsorbent layer and the other receives the reflected light from the adsorbent layer. Continuous or pulsed light may be used for this purpose. The signals obtained from these measurements may be transmitted to a computer that controls the distance of the nozzle from the adsorbent layer. A gap adjustment may be accomplished either by raising/lowering the nozzle or by raising/lowering the table on which the chromatographic plate is placed. The fiber-optic measurement of the distance between the nozzle tip and the adsorbent layer may be performed on a dry plate for a given path of the nozzle movement (such measurement may be performed before developing the chromatogram). The system then may record the curvature profile of the adsorbent layer along a predetermined path and therefore control the gap between the nozzle and the adsorbent layer. Alternatively a quicker (but not as precise) method may include steps to take measurements at multiple different points on the plate (for example at 9, 12, or 15 preset points) and setting the plate curvature profile based on these measurements.

The novel method has a number of important advantages as compared to the prior art:
1. Solvent use is minimized. The eluent is delivered precisely and only to the desired locations on the adsorbent layer at the time of use, so that there is no “wasted” solvent in the process of chromatogram development and there is no solvent evaporation at locations other than the target location of the eluent deposition;
2. Gradient chromatogram is accurate and precise. Dynamic adjustment to the eluent stream delivery allows very accurate control over the entire process;
3. Every change of eluent composition immediately reaches the adsorbent layer, There is no so-called gradient dwell volume (gradient delay). This cannot be achieved with the current techniques because they assume that the eluent is placed in a jar or in a tray and its composition cannot be changed rapidly;
4. Excess flow of the eluent to the adsorbent layer is greatly reduced or entirely eliminated. The method of the invention allows lowering the speed of eluent delivery to the adsorbent layer in comparison to the speed of eluent adsorption by the adsorbent layer. The effect of the outflow of the eluent onto the surface of the adsorbent layer does not occur. This is not achieved by other current methods of chromatography development;
5. The eluent delivery is so precise that it can be used for micro-TLC/lab-on-chip systems. In traditional chromatogram development, the plate is wetted too quickly—solvents move too fast and the separation does not happen correctly; and
6. The invention allows creation of a fully automatic full-featured machine for thin-layer chromatography. No such device exists on the market today, especially when it comes to gradient development of a chromatogram.

It is contemplated that any embodiment discussed in this specification can be implemented with respect to any method of the invention, and vice versa. It will be also understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. AH publications and patent applications are herein incorporated by reference to the same extent as if each individual publication or patent application was specifically and individually indicated to be incorporated by reference. Incorporation by reference is limited such that no subject matter is incorporated that is contrary to the explicit disclosure herein, no claims included in the documents are incorporated by reference herein, and any definitions provided in the documents are not incorporated by reference herein unless expressly included herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), property(ies), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, RCB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered dose enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 10, 12, 15, 20 or 25%

AH of the devices and/or methods disclosed and claimed herein can be made and executed without undue experimentation in light of the present disclosure. While the devices and methods of this invention have been described in terms of preferred embodiments, it will be apparent to those of skill in the art that variations may be applied to the devices and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A method of performing a thin layer chromatography, the method comprising the following steps:
a. providing a chromatography apparatus comprising a three-dimensional machine configured to move a rigid nozzle under control by a computer along a stationary adsorbent layer retained therein, wherein the rigid nozzle is connected to multiple tubing, each tubing is configured to conduct a flow of an individual liquid eluent component therethrough and release thereof from an opening at an open end of the tubing located at the rigid nozzle,
wherein individual eluent components are different from each other in at least one of a qualitative composition or a quantitative composition thereof,
b. individually operating a plurality of pumps for pumping individual eluent components through the respective tubing towards the rigid nozzle, the operating of the plurality of pumps is conducted at variable flow rates controlled by the computer to cause flowing thereof from the respective tubing openings, wherein the tubing openings are positioned at close proximity to each other in the rigid nozzle and to an outer surface of the adsorbent layer so as to cause mixing and aggregating of individual eluent components in a space between the plurality of tubing openings and the adsorbent layer, thereby forming the eluent stream of multiple individual eluent components on the outer surface of the adsorbent layer, the eluent stream is characterized by a moving eluent front surrounding the volume of eluent emanated from the rigid nozzle on the outer surface of the adsorption layer, the eluent front is migrating on the adsorbent layer in response to the individual operating of the plurality of pumps,
c. operating the three-dimensional machine for moving the rigid nozzle adjacent and along the outer surface of the adsorbent layer while continuing to pump individual eluent components for depositing the aggregated eluent stream along a set path on the adsorbent layer,
d. operating a camera connected to the computer to observe a migration of the eluent front on the adsorbent layer, and
e. individually adjusting flow rates of individual pumps in steps (b) and (c) by the computer using a dynamic position of the eluent front as observed in step (d) by the camera connected thereto,
thereby delivering the eluent stream to a desired location on the adsorbent layer to cause sorption thereof to develop the thin layer chromatogram thereon suitable for subsequent quantitative analysis.

2. The method of performing a thin layer chromatography as in claim 1, wherein the plurality of pumps comprising a plurality of positive displacement pumps, each positive displacement pump is configured to cause a flow of an individual eluent component through the respective tubing towards the rigid nozzle in steps (b) and (c).

3. The method of performing a thin layer chromatography as in claim 2, wherein each positive displacement pump is a syringe pump.

4. The method of performing a thin layer chromatography as in claim 1, wherein the step (d) of individually adjusting flow rates of individual pumps further comprises a step of detecting a speed of migration of the eluent front towards a predetermined target position on the adsorbent layer.

5. The method of performing a thin layer chromatography as in claim 1, wherein the step (d) of individually adjusting flow rates of individual pumps further comprises a step of detecting a distance between a current position of the eluent front and the predetermined target position thereof on the adsorbent layer.

6. The method of performing a thin layer chromatography as in claim 5, wherein the step (d) of individually adjusting flow rates of individual pumps further comprises a step of reducing flow rates of one or ore individual pumps as the distance between the current position of the eluent front and the predetermined target position thereof is reduced on the adsorbent layer.

7. The method of performing a thin layer chromatography as in claim 1, wherein steps (b), (c), and (e) of pumping individual eluent components and moving the rigid nozzle are conducted automatically using a predetermined computer program based on observed migration of the eluent front in step (d).

8. The method of performing a thin layer chromatography as in claim 1, wherein in step (c) the moving of the rigid nozzle is conducted at least in part in a repetitive “back and forth” pattern over the same area of the adsorbent layer between a first turning point and a second turning point, thereby increasing volume of the eluent stream deposited thereon,

9. The method of performing a thin layer chromatography as in claim 8, wherein in step (c) of moving the rigid nozzle, a speed of travel of the rigid nozzle in a direction from the first turning point to the second turning point, while conducting the repetitive pattern, differs from a speed of travel thereof in the opposite direction from the second turning point to the first turning point.

10. The method of performing a thin layer chromatography as in claim 9, wherein in step (c) of moving the rigid nozzle, the speed of travel of the rigid nozzle from the first turning point to the second turning point is lower than the speed of travel thereof in the opposite direction from the second turning point to the first turning point.

11. The method of performing a thin layer chromatography as in claim 8, wherein in step (c) the set path for moving of the rigid nozzle comprises a plurality of line styles.

12. The method of performing a thin layer chromatography as in claim 1, wherein in step (c) the eluent stream is successively roved adjacent to outer surfaces of at least two separate adsorbent layers.

13. The method of performing a thin layer chromatography as in claim 1, wherein the flow of eluent stream in step (b) and step (c) is selected to be lower than a rate of absorbency thereof by the adsorbent layer.

14. The method of performing a thin layer chromatography as in claim 1, wherein the flow of eluent stream in step (b) and step (c) is selected to exceed the rate of absorbency thereof by the adsorbent layer.

15. The method of performing a thin layer chromatography as in claim 1, wherein the rigid nozzle further comprises a collector with a plurality of inputs attached respectively to multiple tubing and configured to accept and mix corresponding flows of individual eluent components, thereby forming the aggregated eluent stream of multiple individual eluent components emanating therefrom.

16. The method of performing a thin layer chromatography as in claim 1, wherein step (c) further comprises a step of stimulating the eluent stream emanating from the rigid nozzle by transverse vibrations thereof.

17. The method of performing a thin layer chromatography as in claim 1, wherein in step (b) and step (c) the pumping of individual eluent components is done in a continuous flow stream to minimize forming of individual droplets of any individual eluent component.

18. The method of performing a thin layer chromatography as in claim 1, further comprising a step of obtaining a curvature profile of the adsorbent layer along the set path and conducting step (c) while maintaining a predefined constant gap distance between the rigid nozzle and the adsorbent layer using the three-dimensional machine.

19. The method of performing a thin layer chromatography as in claim 18, wherein the predefined gap is from 0.05 mm to 1.0 mm.
